(19) United States
(12) Patent Application Publication
(10) Pub. No.: US 2025/0208797 A1
(43) Pub. Date: Jun. 26, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SATOSHI OTAKA, Kanagawa (JP)

(21) Appl. No.: 18/978,066

(22) Filed: Dec. 12, 2024

(30) Foreign Application Priority Data
Dec. 20, 2023 (JP) 2023-214528

(51) Int. Cl. G06F 3/12; G06T 7/00

(52) U.S. Cl. CPC G06F 3/1208; G06F 3/1204; G06F 3/1256; G06T 7/0008; G06F 3/1288; G06T 2200/24; G06T 2207/20084; G06T 2207/30144; G06T 2207/30168

(57) ABSTRACT

An image completion processing unit sets an ID indicating a content set in an image input unit. The image input unit determines whether a content type corresponding to the specified ID is “image”. The image completion processing unit determines whether a missing portion is present in the input image, and identifies the missing portion. The image completion processing unit sets a completion region in a region adjacent to the missing portion of the input image and outside the input image. The image completion processing unit requests an image generation unit of a server to generate a completed image based on information set in the image input unit and completion region information. The image generation unit generates the completed image with a generative AI technology using a generative model, transmits the generated completed image to the image completion processing unit of a client PC, and terminates processing.

### BACKGROUND

### Field

The present disclosure relates to an information processing technique for completion a missing portion of an input image.

### Description of the Related Art

In recent years, a service that supports production of a poster or a flyer is provided. The service supports the production such that anyone can easily obtain a product with a certain level of quality by editing a layout based on multiple templates prepared in advance.

In the case where an image owned by the user is to be used in the selected templated, there is a case where a portion of an object in the image is missing. In the case where the missing portion is an essential portion, the user needs to prepare another image suiting the usage purpose again.

In recent years, generation of a necessary content is becoming possible with a generative AI technology. In the generative AI technology, the user inputs an image or a text as an input prompt into a generative model. Then, the generative AI technology can generate a text, an image, a moving image or the like that matches a “context” expressed by the inputted prompt at high probability. Using this technique allows the user to easily obtain an image (completed image) in which the missing portion is completed. However, the user needs to specify which portion of the image is to be completed.

Japanese Patent Laid-Open No. 2008-250046 discloses a technique of automatically correcting image data for performing image generation of an original, based on a read image of the original and ground truth data. In Japanese Patent Laid-Open No. 2008-250046, the read image of the original and the ground truth data in which multiple lines varying in boldness and orientation are drawn are compared with each other to detect a missing portion such as a broken line and a change in line width in the read image, and the image data for performing the image generation of the original is automatically corrected.

However, the technique described in Japanese Patent Laid-Open No. 2008-250046 has the following problems. It is necessary to prepare the ground truth data in advance and read the ground truth data every time the correction is performed. Moreover, the correction target is limited to a line image.

### SUMMARY

The present disclosure provides an information processing apparatus including: an obtaining unit configured to obtain an input image; an extraction unit configured to extract an object from the input image; an identification unit configured to identify a missing portion of the object extracted by the extraction unit, based on a feature of an outline of the object; and a generation unit configured to generate a completed image in which the missing portion identified in the input image is completed.

Further features of the present disclosure will become apparent from the following description of exemplary embodiments with reference to the attached drawings.

### BRIEF DESCRIPTION OF THE DRAWINGS

FIG. 1 is an example of a system configuration relating to a layout data editing apparatus targeted at an image output apparatus in the present embodiment;

FIG. 2 is an example of a hardware configuration of the image output apparatus in the present embodiment;

FIG. 3 is an example of a hardware configuration a client PC and a server in the present embodiment;

FIG. 4 is an example of a functional block of a print system targeted at the image output apparatus in the present embodiment;

FIG. 5 is an example of image generation processing using a generative model;

FIG. 6 is an example of a layout data DB in the present embodiment;

FIG. 7 is a diagram illustrating an example of a layout data editing screen in a client PC in the present embodiment;

FIG. 8 is an example of a processing flow in which a completed image is generated in layout data editing in Embodiment 1;

FIG. 9 is an example of image completion processing using a generative model;

FIG. 10 is an example of a processing flow in which the completed image is generated in cut-out of a content in Embodiment 2;

FIG. 11A is an example of an arrangement position of the content;

FIG. 11B is an example of the arrangement position of the content;

FIG. 12 is an example of a processing flow in which whether the completed image is to be generated or not is determined based on the arrangement position of the content in Embodiment 3;

FIG. 13 is an example of a processing flow in which multiple completed images are generated in Embodiment 4;

FIG. 14 is an example of a processing flow in which the completed image is generated by using a text prompt in Embodiment 5;

FIG. 15 is an example of a processing flow in which a missing portion of the generated completed image is completed in Embodiment 6;

FIG. 16 is an example of a processing flow in which whether the completed image is to be generated or not is received from a user in Embodiment 7;

FIG. 17A is an example in which the extracted object is fragmented;

FIG. 17B is an example in which the extracted object is fragmented;

FIG. 17C is an example in which the extracted object is fragmented;

FIG. 18 is an example of a processing flow in which, in the case where the same object is extracted as multiple objects in the cut-out processing of the content, a region between the multiple objects forming the same object is set as the completion region and the completed image is generated in Embodiment 8;

FIG. 19 is an example of a processing flow in which the completion region where the completed image is to be generated is received from the user in Embodiment 9;

FIG. 20A is an example of a dialog in which the user sets the completion region where the completed image is to be generated;

FIG. 20B is an example of the dialog in which the user sets the completion region where the completed image is to be generated;

FIG. 21A is an example of overlapping of contents;

FIG. 21B is an example of the overlapping of contents;

FIG. 22 is an example of a processing flow in which whether the completed image is to be generated or not is determined based on an overlapping state of the contents in Embodiment 10; and

FIG. 23 is an example of a processing in which multiple completed images varying in the completion region are generated in Embodiment 11.

### DESCRIPTION OF THE EMBODIMENTS

Preferable embodiments of the present disclosure are explained below in detail with reference to the attached drawings. Note that the following embodiments do not limit the present disclosure relating to the scope of claims, and not all of combinations of features explained in the present embodiments are necessarily essential for the solving means of the present disclosure.

### Embodiment 1

First, an information processing system according to the present embodiment is explained. The information processing system according to the present embodiment is a print system involving layout data editing for an image output apparatus. In the print system, editing of layout data and print job transmission to the image output apparatus are performed in an externally-connected PC. In print job generation, editing work of print setting is performed on a screen of the PC as necessary.

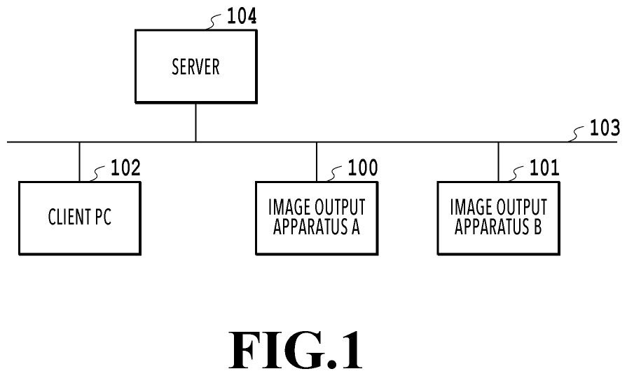

FIG. 1 is a diagram illustrating an example of a system configuration in a network environment of the present system. As illustrated in FIG. 1, a client PC 102 can be connected to a server 104 and image output apparatuses (100 to 101) via a network 103. In the client PC 102, the editing work of the layout data relating to print products and documents such as posters and flyers is performed, and requests to perform rendering processing and part of editing and data processing relating to the layout data is made to the server 104. Moreover, in the client PC 102, data obtained by adding the print setting to the layout data after the editing work is generated as a print job, and the print job is transmitted to the image output apparatus 100 or 101. Although there are two image output apparatuses in the present embodiment, the number of image output apparatuses is not limited to this, and may be one or three or more. Although there are one client PC and one server, the number of the client PCs and the number of the servers may be two or more.

In the present document, a system in which the print job is transmitted from a printing application installed in the PC to the image output apparatus 100 via a printer driver is explained as an example of execution of printing. For example, the printing application and the printer driver are installed in the client PC 102. The printing application can obtain device information of the associated image output apparatus 100 and print parameters such as a type of sheet, a sheet size, and a print quality from the printer driver, and perform print setting editing of a parameter from among the obtained parameters. The print job is formed based on the above-mentioned print setting and a layout data image for which rendering processing is completed in the server 104, and the print job is transmitted to the image output apparatus via a spool of the printer driver to execute print processing. In the image output apparatus, the printing is executed based on the print setting in the received print job. Moreover, in the image output apparatus, configuration information relating to the handled inks and sheets and status information such as an idling state and a print error are held as the device information. Furthermore, in the case where the printing cannot be normally executed due to an error in the print setting or a problem in the image output apparatus such as lack of remaining sheets and ink empty, a warning message is displayed on a main body panel to present the reason why the printing cannot be normally executed to the user.

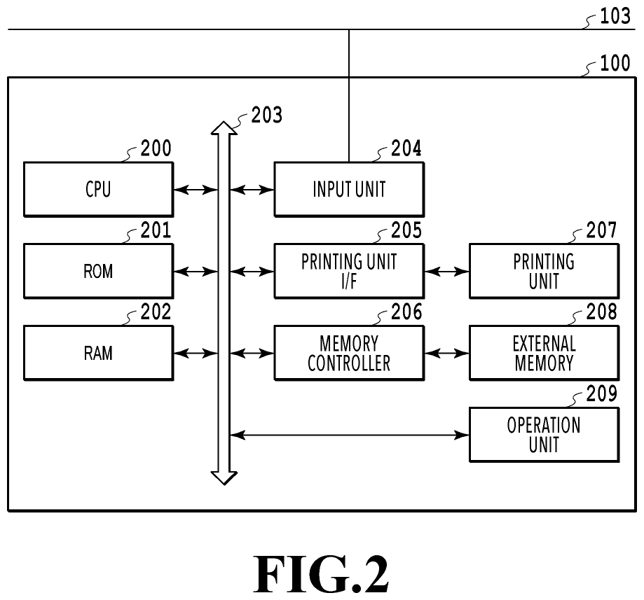

FIG. 2 is a diagram illustrating an example of a hardware configuration of the image output apparatus 100. Note that since the image output apparatus 101 also has the same configuration, explanation thereof is omitted. The image output apparatus 100 is controlled by a CPU 200. The CPU 200 operates based on a control program or the like stored in a program ROM of a ROM 201 or a control program or the like stored in an external memory 208. The CPU 200 outputs an image signal as output information to a printing unit (printer engine) 207 connected to a printing unit I/F 205 via a system bus 203. The CPU 200 can perform communication processing with the client PC 102 via an input unit 204, and can notify the client PC 102 of information in the image output apparatus 100. Moreover, the CPU 200 can receive output data to be outputted to the printing unit 207 via the input unit 204. A RAM 202 is a RAM that functions as a main memory, a work area, or the like of the CPU 200, and is configured such that a memory capacity thereof can be expanded by an option RAM connected to a not-illustrated expansion port. Note that the RAM 202 is used as an output information development region, an environment data storage region, a non-volatile memory, and the like. Access to the external memory 208 such as a hard disk drive (HDD) or an IC card is controlled by a memory controller 206. The external memory 208 can be connected as an option, and information such as main body status information and information on font data, an emulation program, form data, used inks, and types and sizes of fed sheets are stored in the external memory 208. Moreover, an operation unit 209 includes a panel, and various types of information can be displayed on the operation unit 209.

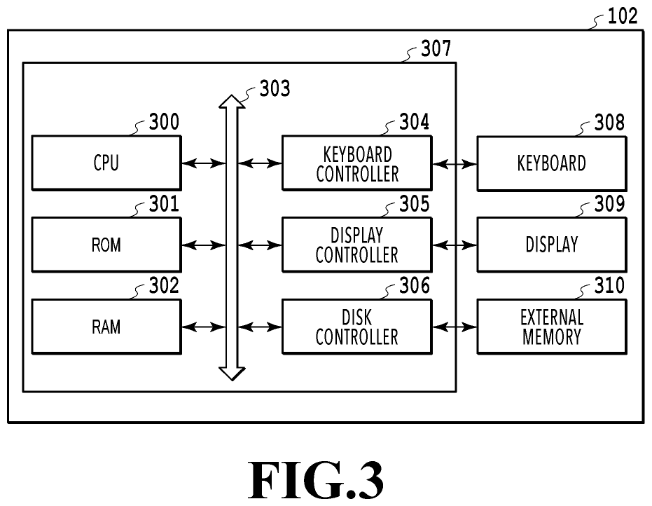

FIG. 3 is an example of a block diagram illustrating a configuration of a computer of the client PC 102 and the server 104 in FIG. 1. A computer interior 307 includes a CPU 300, a ROM 301, a RAM 302, a keyboard controller 304, a display controller 305, and a disk controller 306. The CPU 300 reads various programs such as a control program, a system program, and an application program from an external memory 310 out to the RAM 302 via the disk controller 306. The CPU 300 performs various types of data processing and performs display control of a display 309 by executing the various programs read out to the RAM 302. The CPU 300 may read out the control program and the like from the ROM 301. The CPU 300 may be a dedicated circuit such as an ASIC. The CPU 300 and the dedicated circuit are examples of a hardware circuit and a hardware processor. The disk controller 306 controls access to the external memory 310 such as an HDD, a CD-ROM, a DVD-ROM, and a USB. The RAM 302 is configured such that a capacity thereof can be expanded by a not-illustrated option RAM, and is mainly used as a work area of the CPU 300. The keyboard controller 304 controls key input from a keyboard 308 and a not-illustrated pointing device. The display controller 305 controls display of the display 309. In the embodiments of the present disclosure, the CPU 300 controls the units connected to a main bus 303 via the main bus 303 unless otherwise noted. As a matter of course, a configuration that is not necessarily essential such as the display 309 may not be included in the configurations of the server 104.

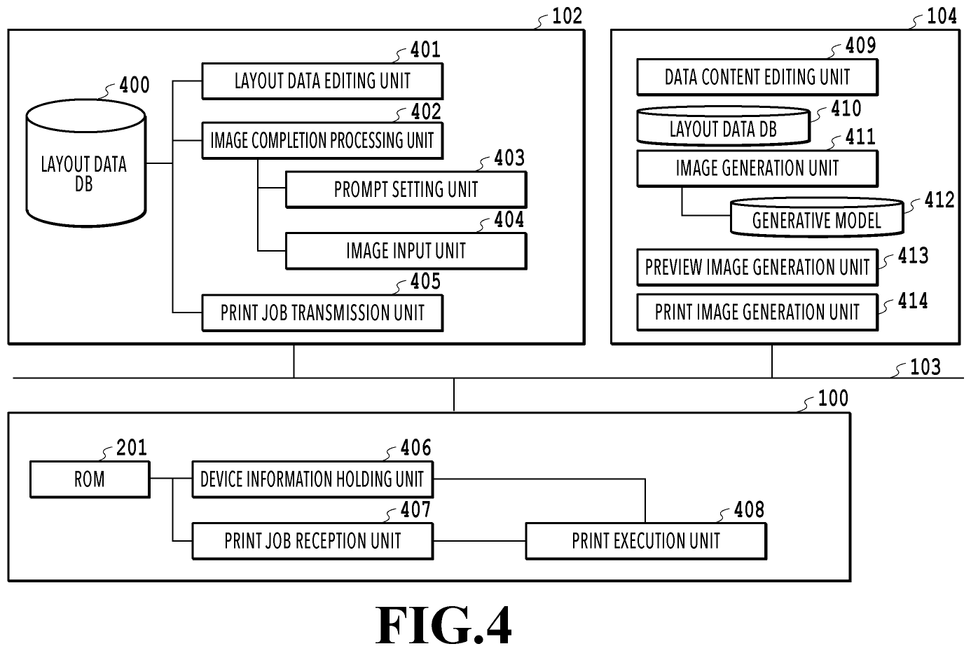

FIG. 4 is a diagram illustrating an example of functional blocks of the present system relating the image output apparatuses 100 and 101, the client PC 102, and the server 104 explained in FIGS. 1 to 3. First, the functional blocks in the client PC 102 and the server 104 are explained.

A layout data editing unit 401 adds and deletes contents such as a text and an image to be put on a poster or a flyer, and adjusts layout of the contents. In the case where processing such as cut-out and filling is performed on the contents, the layout data editing unit 401 requests a data content editing unit 409 of the server 104 to perform the processing. The layout data is saved in a layout data DB 400 of the client PC 102 as a cache, or is saved in a layout data DB 410 of the server 104 for each client PC 102 (or for each account in the case where there is a user account).

A print job transmission unit 405 generates the print job, and transmits the generated print job to the image output apparatus 100. In the case where the print job transmission unit 405 generates the print job, the print job transmission unit 405 requests a preview image generation unit 413 and a print image generation unit 414 of the server 104 to perform processing of generating a preview or a print image of the layout data.

An image completion processing unit 402 requests an image generation unit 411 of the server 104 to perform image generation based on image information set in an image input unit 404. The image generation unit 411 of the server 104 requested to perform the image generation generates a completed image by using a generative model 412, and transmits the generated completed image to the client PC 102. The client PC 102 receiving the completed image provides the completed image to the user from the image completion processing unit 402. Moreover, the image completion processing unit 402 can request the image generation unit 411 of the server 104 to perform the image generation based on prompt information set in a prompt setting unit 403 together with the image information set in the image input unit 404.

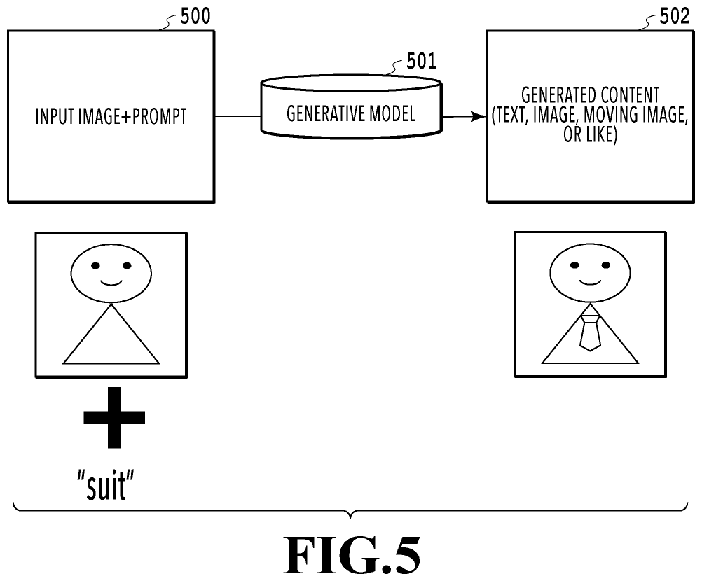

The generative model 412 used by the image generation unit 411 for the generation of the completed image is a machine-learned generative model that performs the image generation by using a diffusion model or the like used in GAN (generative adversarial network), Stable Diffusion, or DALL E. FIG. 5 is a diagram for explaining image generation processing using the generative model. In the case where a generative model 501 receives an input 500 formed of an input image and a text prompt, the generative model 501 can output an image matching a “context” expressed by the input 500, as a generated content 502. Note that the generative model 501 can generate different images by using the same input image and the same text prompt by changing a seed value of a random number generator for generating an initial value in the image generation.

Next, the functional blocks in the image output apparatus 100 are explained. The ROM 201 includes a device information holding unit 406, a print job reception unit 407, and a print execution unit 408. The device information holding unit 406 holds information such as types and remaining amounts of inks installed in the image output apparatus 100, information such as types and sizes of registered sheets and fed sheets, main body status information of the image output apparatus 100, and status information of the print job. The print job reception unit 407 receives the print job transmitted from the client PC 102. The print execution unit 408 executes the print processing for the print job.

Note that the information held by the device information holding unit 406 may be held on the client PC 102 side or the server 104 side while being associated with the layout data DB 400 or 410. This allows the client PC 102 or the server 104 to generate the layout data suiting the image output apparatus 100 to be used in the case where the image output apparatus 100 to be used is determined in advance.

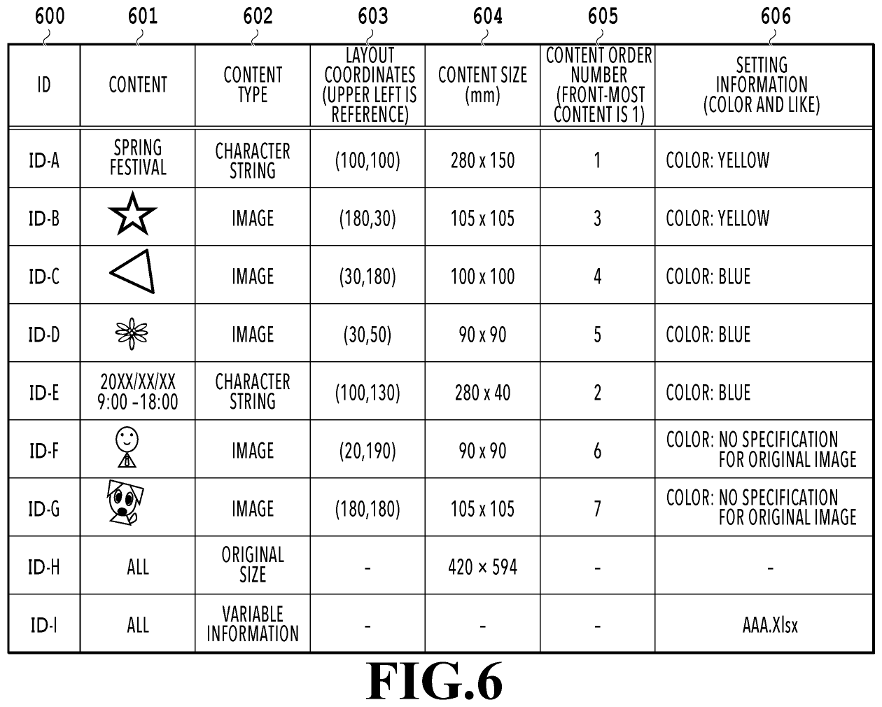

FIG. 6 illustrates an example of the layout data stored in the layout data DB 400 or 410. There is a data table as illustrated in FIG. 6 for each piece of layout data. The data table includes parameters such as an ID 600 for uniquely identifying a content, a content 601, a content type 602, layout coordinates 603, a content size 604, a content order number 605, and setting information 606. An address value where data of each content such as a text, an image, or the like is stored is set in the content 601. Information indicating the type of content is set in the content type 602. Coordinate values indicating the position of the content are set in the layout coordinates 603. Values indicating the size of the content are set in the content size 604. A value indicating an overlapping order number of each of the contents that are arranged in multiple different layers and that are specified by the different content IDs are set in the content order number 605. An attribute value of each content such as a color of the content is set in the setting information 606. Moreover, the layout data can hold not only the information on each content but also various pieces of setting information on the entire layout such as an original size and data for variable printing. Registering “all” in the content 601 and registering the setting type and the setting value in the content type 602 and the setting information 606, respectively, allows setting information for the entire layout to be held in the layout data. Note that the information held in the layout data is not limited to the information on each content and the setting information on the entire layout, and information on parameter types other than those described above may be included in the layout data, or the layout data may be separate pieces of data for the respective parameter types.

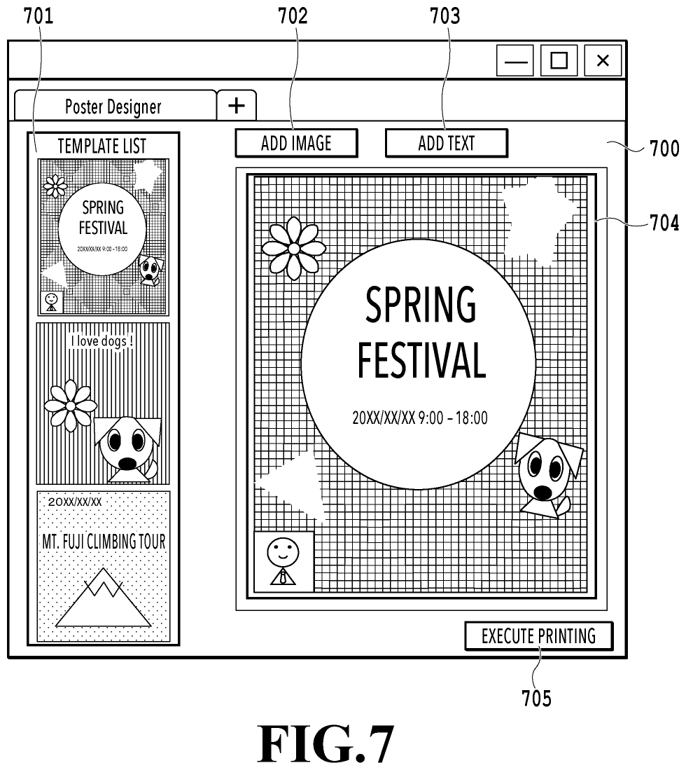

FIG. 7 is an example of a layout data editing screen 700 displayed in the client PC 102. Multiple templates are displayed in a template list 701, and the user can select a template thought to be closest to a finished image of the layout data from among the displayed multiple templates. In the case where the user selects the template, the selected template is displayed in a layout editing area 704. Template information displayed in the template list 701 may be obtained from the layout data DB 400 or 410, or obtained from an SNS or another external cloud service.

In the layout editing area 704, the layout data editing unit 401 or the data content editing unit 409 can perform editing such as position adjustment, cut-out, and filling on each displayed content. Addition of a content such as an image or a text to the layout editing area 704 is performed by, for example, pressing an image addition button 702 or a text addition button 703 and specifying a path of a content file as an import source. Note that a button corresponding to each type of content may be added in addition to the image addition button 702 and the text addition button 703. Moreover, a storage of an SNS or another external cloud service may be specifiable as the import source of the content, in addition to a local storage of the client PC 102. Furthermore, addition of a content to the layout editing area 704 through drag and drop may be receivable.

In the case where the layout data editing unit 401 detects the pressing of a printing execution button 705, the layout data editing unit 401 requests the print job transmission unit 405 to generate and transmit the print job to execute printing. The print job transmission unit 405 requested to generate and transmit the print job generates the print job of the layout data displayed in the layout editing area 704, and transmits the generated print job to the image output apparatus A 100 or the image output apparatus B 101.

In the present embodiment, in the case where a missing portion is present in an object in an input image instructed by the user to be added to the layout data editing screen 700, the completed image in which this missing portion is completed can be generated and displayed in the layout data editing screen. The image completion processing unit 402 sets, in the image input unit 404, the input image added by pressing of the image addition button 702, transmits the set input image to the server 104, and receives the completed image generated by the image generation unit 411 from the server 104. The image completion processing unit 402 provides the completed image to the user by displaying the completed image on the layout data editing screen 700. Moreover, the image completion processing may be executable from a context menu.

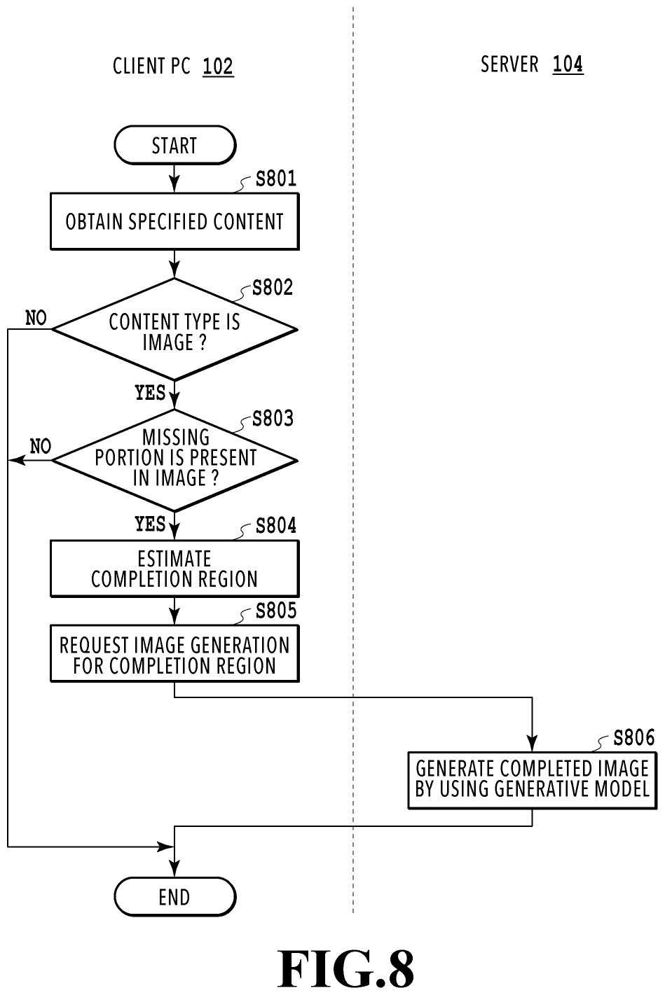

FIG. 8 is an example of a processing flow in which the completed image is generated and displayed on the layout data editing screen 700. The CPU 300 implements the flowchart illustrated in FIG. 8 by, for example, reading the program stored in the ROM 301 out to the RAM 302 and executing the program. For example, in the case where the image addition button 702 on the layout data editing screen 700 is pressed and an image is added, the client PC 102 causes the image completion processing unit 402 to start the present flow.

In S801, the image completion processing unit 402 sets the ID 600 indicating the content set in the image input unit 404.

In S802, the image input unit 404 determines whether the content type 602 corresponding to the specified ID 600 is “image” or not. In the case where the content type 602 is not “image” (No in S802), the image completion processing unit 402 directly terminates the processing. In the case where the content type 602 is “image” (Yes in S802), the processing proceeds to S803.

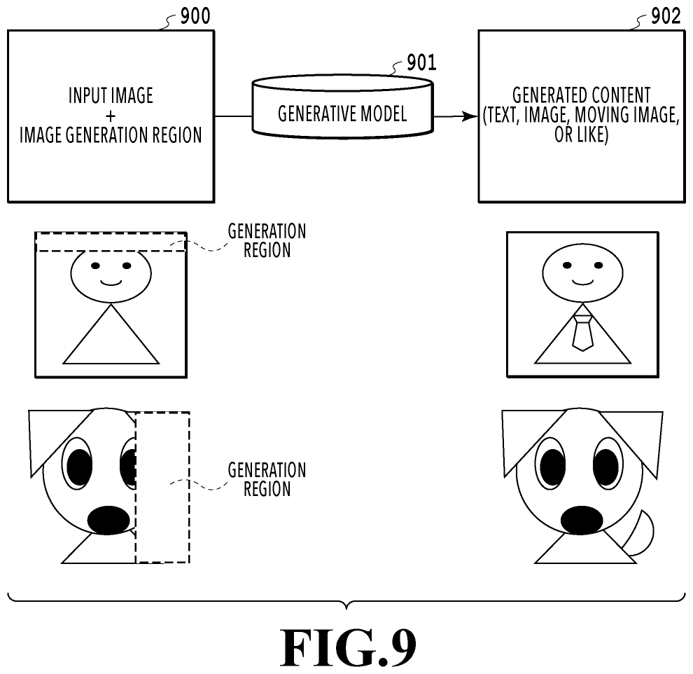

In S803, the image completion processing unit 402 determines whether a missing portion is present in the input image or not, and identifies the missing portion. The missing portion being present means that part of an object of a predetermined type such as a person or an animal is unnaturally missing as in the input image illustrated in FIG. 9. In this example, in the case where the object of the predetermined type is present in the input image, an outline of this object is extracted, and a straight line portion where the extracted outline satisfies a missing determination criterion described below is identified as the missing portion. An example of the missing determination criterion of the input image can be whether or not at least part of the outline of the object of the predetermined type such as a person or an animal matches at least one of upper, lower, left, and right end portions of the input image. Specifically, in the case where multiple consecutive pixels forming the outline of the object of the predetermined type are pixels of an end portion of the input image and the above-mentioned missing determination criterion is satisfied, the missing portion is determined to be present. Moreover, there are other missing determination criteria as follows. For example, Hough transform of detecting a straight line is performed on pixels forming the outline, and whether or not a parameter of the straight line has a peak within a predetermined width may be used as the missing determination criterion. Moreover, a regression line is obtained, and whether or not a coefficient of determination of this regression line is a predetermined value or more may be used as the missing determination criterion. In the straight line portion determined as the missing portion, a variation of positions of the pixels corresponding to this straight line portion with respect to a straight line calculated based on the positions of these pixels is equal to or less than a predetermined threshold. In the case where the missing portion is absent in the input image (No in S803), the image completion processing unit 402 directly terminates the processing. In the case where the missing portion is present in the input image (Yes in S803), the processing proceeds to S804.

In S804, the image completion processing unit 402 sets a completion region in a region that is adjacent to the missing portion of the input image and that is outside the input image. The size of the completion region is as follows. For example, in the case where the right side of the input image is the missing portion, a width ¼ of the width size of the input image is set as the width of the completion region, and the same height as the input image is set as the height of the completion region. In the case where the upper side of the input image is the missing portion, the same width as the input image is set as the width of the completion region, and a height ¼ of the height of the input image is set as the height of the completion region. Note that the completion region is not limited to a region set as described above, and may be a region with a predetermined fixed size irrespective of the size of the input image. Moreover, the shape of the completion region may be changed depending on the shape of the object determined to have the missing portion. For example, in the case where a head portion of a person is missing as in the example of FIG. 9, a circular completion region may be set along the shape of the head portion, for the head portion of the person. As a matter of course, the shape of the completion region is not limited to the rectangular and circular shapes, and may be any shape.

In S805, the image completion processing unit 402 requests the image generation unit 411 of the server 104 to generate the completed image based on the information set in the image input unit 404 and completion region information.

In S806, the image generation unit 411 generates the completed image with a generative AI technology using the generative model 412, transmits the generated completed image to the image completion processing unit 402 of the client PC 102, and terminates the processing.

Note that the configuration may be such that a flag indicating whether the image completion processing is to be performed or not is used in addition to the content type for the determination of whether to perform the image completion processing or not in S802. For example, the configuration may be such that the flag is set for each content, and in the case where the flag is “TRUE”, the image missing portion determination and the generation of the completed image are performed. Meanwhile, in the case where the flag is “FALSE”, the processing is directly terminated.

In the present embodiment, as described above, the image complementation is performed on the image with the missing portion. Accordingly, it is possible to omit work of the user preparing another image without the missing portion or preparing ground truth data for specifying how the complementation is to be performed. Moreover, since the image completion function is incorporated in the processing of importing the input image, the user does not have to abort the layout editing and separately perform the image completion processing, and can seamlessly perform the layout editing.

### Embodiment 2

As described above, the editing of content itself such as position adjustment, cut-out, and filling can be performed on each of the contents displayed in the layout editing area 704. Accordingly, in the present embodiment, the generation of the completed image is performed along with the cut-out processing of each content performed in the content editing.

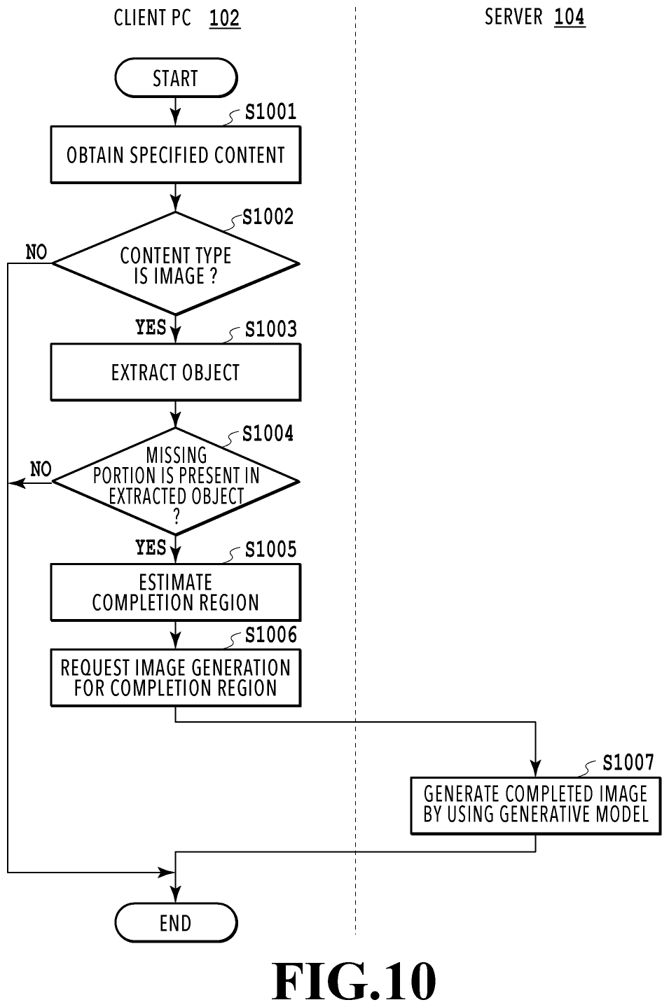

FIG. 10 is a flowchart for explaining an example of a processing method in which the completed image is generated in cut-out of the content in the layout data editing screen 700. The present flow is started by the image completion processing unit 402, for example, in the case where the client PC 102 receives an instruction of executing the cut-out processing on the image on the layout data editing screen 700 from the user. Note that explanation of the same processes as those in the above-mentioned Embodiment 1 is omitted.

S1001 to S1002 are the same as S801 to S802.

In S1003, the image completion processing unit 402 performs the cut-out processing on each content, that is performs object extraction. The object is an object to be a foreground such as a person or an animal in the image, and the object extraction is processing of cutting out the foreground such as the person or the animal from the input image, that is processing of removing a background.

In S1004, the image completion processing unit 402 determines whether or not the missing portion is present in the extracted object such as the person or the animal. Examples of a method of determining whether or not the missing portion is present in the extracted object includes methods such as the method of determining whether or not at least part of the outline of the extracted object matches at least one of the upper, lower, left, and right end portions of the input image as in Embodiment 1 or the like. In the case where the missing portion is absent in the object (No in S1004), the image completion processing unit 402 directly terminates the processing. In the case where the missing portion is present in the object (Yes in S1004), the processing proceeds to S1005.

S1005 to S1007 are the same as S804 to S806.

Note that the image used in the case where the image completion processing unit 402 requests the image generation unit 411 of the server 104 to perform the image generation in S1006 may be either the image after the object extraction, that is the image after removal of the background from the input image or the input image before the object extraction. As a matter of course, in the case where the input image before the object extraction is used, the object extraction is performed again before the completed image is provided to the user. Moreover, in the case where the image after the object extraction used, a white or black image may be used as the background. As a matter of course, the background image is removed again before the completed image is provided to the user.

In the present embodiment, as described above, in the case where the missing portion is present in the object cut out from each content, the image complementation is performed. Accordingly, as in Embodiment 1, work of the user preparing another input image without the missing portion can be omitted. Moreover, since the completion function is provided in the cut-out processing, the user does not have to abort the layout editing and separately perform the image completion processing, and can seamlessly perform the layout editing.

### Embodiment 3

In the present embodiment, whether the generation of the completed image is performed or not is determined based on an arrangement position of the content.

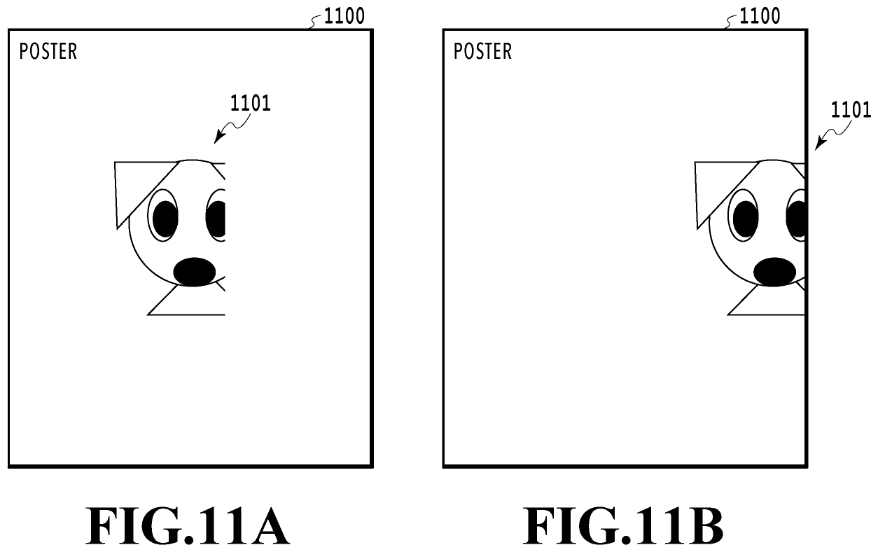

FIG. 11A is an example in which a content 1101 whose right side is missing is arranged at the center of a layout region 1100. In this case, it is assumed that a poster or flyer with a higher level of completeness can be obtained by completion the missing portion of the content 1101.

FIG. 11B is an example in which the content 1101 whose right side is missing is arranged on the right side of the layout region 1100. In this case, a position of an end portion of the layout region 1100 matches a position of the missing portion of the content 1101. Accordingly, it is assumed that complementation of the missing portion of the content 1101 is unnecessary. Note that it is assumed that the complementation of the missing portion of the content 1101 is unnecessary also in the case where the missing portion of the content 1101 is arranged to be located outside the layout region 1100.

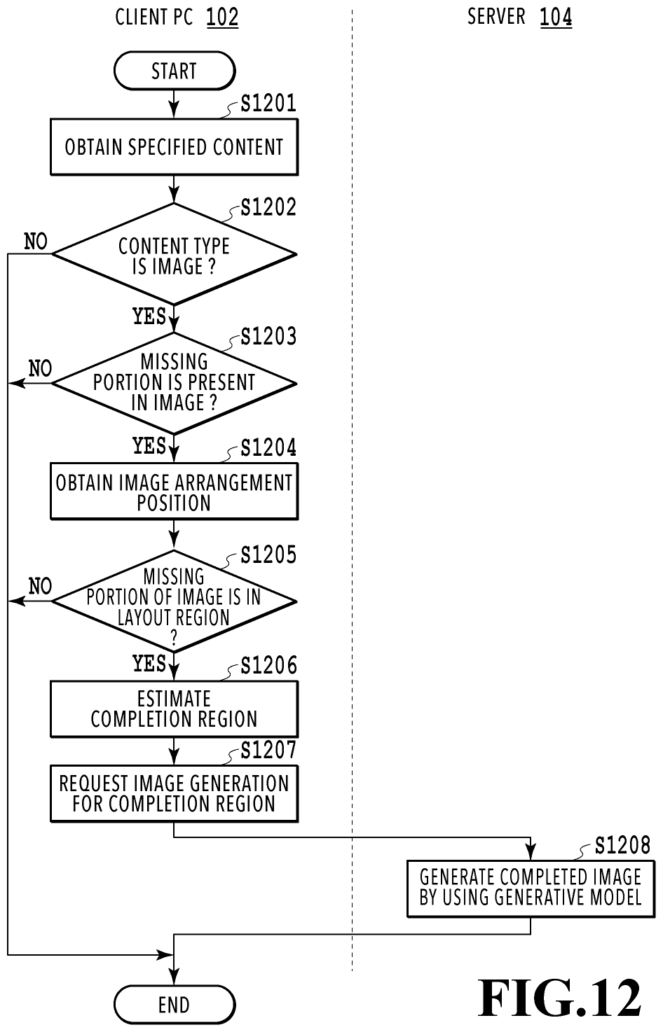

FIG. 12 is a flowchart for explaining a processing example in which whether the generation of the completed image is to be performed or not is determined based on the arrangement position of the content in the layout data editing screen 700. Explanation of the same processes as those in the above-mentioned embodiments is omitted. S1201 to S1203 are the same as S801 to S803.

In S1204, the image completion processing unit 402 obtains the image arrangement position based on the layout coordinates 603 indicating the position of the content set in the image input unit 404 and the content size 604 indicating the size of the content.

In S1205, the image completion processing unit 402 determines whether or not the arrangement position of the missing portion of the input image is within the layout region. Specifically, in the case where the content 1101 whose right side is missing is arranged at the center of the layout region 1100 as in FIG. 11A, in S1205, the image completion processing unit 402 determines that the missing portion is present in the layout region 1100. In the case where the content 1101 is arranged such that the missing portion is located at a right end of the layout region 1100 or outside the layout region 1100 as in FIG. 11B, in S1205, the image completion processing unit 402 determines that the missing portion is absent in the layout region 1100. In the case where the result of the determination of presence or absence of the missing portion is “absent” (No in S1205), the image completion processing unit 402 directly terminates the processing. In the case where the result of the determination of presence or absence of the missing portion is “present” (Yes in S1205), the processing proceeds to S1206.

In S1206, the image completion processing unit 402 sets the completion region as in S804. In the case where the arrangement positions of the input image and the missing portion of the input image are determined, the determination may be performed based on the layout region 1100. Moreover, the configuration may be such that the information in the device information holding unit 406 is obtained from the image output apparatus 100 in addition to the layout region 1100, and the determination is performed based on a region in which an image can be drawn.

S1207 to S1208 are the same as S805 to S806.

In the present embodiment, as described above, processing with high calculation cost can be reduced by not performing unnecessary image generation processing even in the case where the missing portion is present in the input image. Accordingly, it is possible to reduce processing load and reduce work time of the user.

### Embodiment 4

The completed image generated by the generative model is not always an image expected by the user. Meanwhile, as explained by using FIG. 5, changing the seed value of the random number generator that generates the initial value used in the generative model can change the generated content 502. Accordingly, the configuration may be such that multiple completed images are generated and the user selects the image to be used.

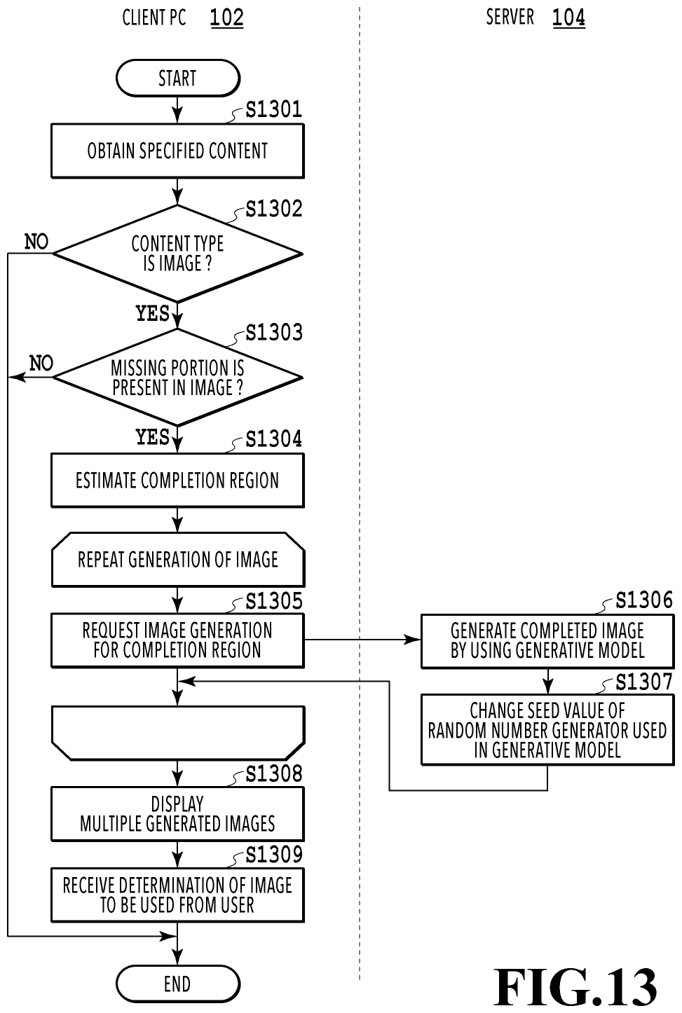

FIG. 13 is an example of a processing flow in which multiple completed images are generated in the layout data editing screen 700. Explanation of the same processes as those in above-mentioned embodiments is omitted.

S1301 to S1306 are the same as S801 to S806.

In S1307, the image generation unit 411 changes the seed value of the random number generator for generating the initial value used in the generative model used in the generation processing of the completed image.

After the execution of S1307, the processing returns to S1305, and S1305 to S1307 are repeated multiple times. The number of times of repeating may be a fixed predetermined number, or may be a number set by the user every time the processing is performed.

In S1308, the image completion processing unit 402 displays the generated multiple completed images on the display 309.

In S1309, the image completion processing unit 402 receives input of selection of one of the displayed multiple completed images by the user, finalizes the completed image to be used, and terminates the processing.

As explained above, in the present embodiment, an image closer to the intention of the user can be provided by providing multiple completed images for the input image with the missing portion.

### Embodiment 5

As illustrated in FIG. 4, the image completion processing unit 402 can set, in addition to the input image, the text prompt for performing instructions relating to the image generation processing by using a text. Setting conditions by using not only the image but also the text enables generation of a more accurate image. Accordingly, in the request of image generation to the image generation unit 411, the information on the text may be handed over in addition to the image.

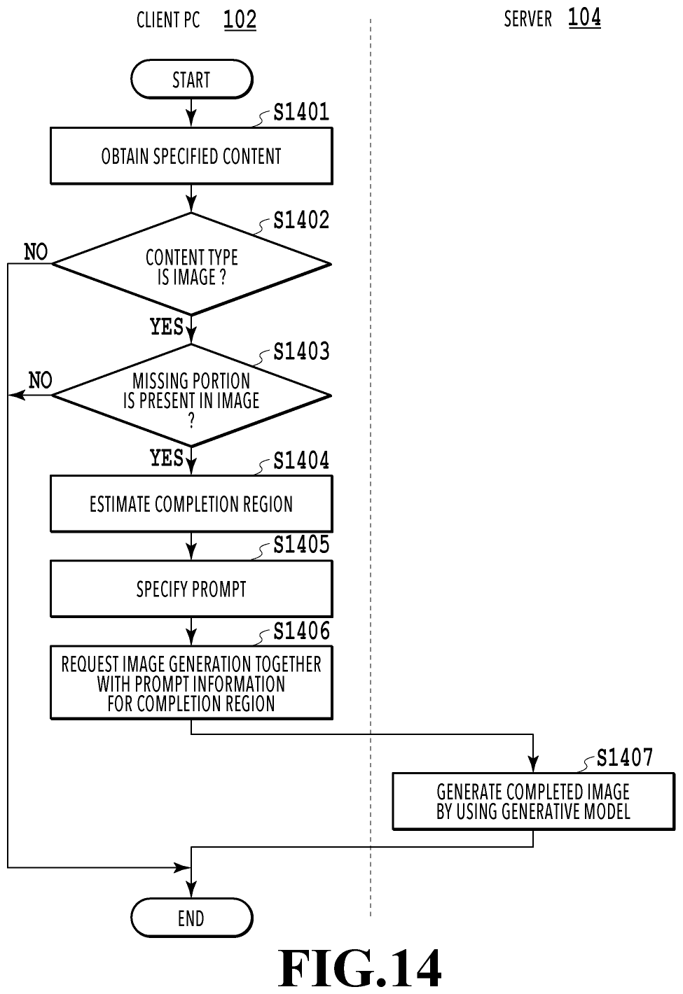

FIG. 14 is an example of a processing flow in which, in the generation of the completed image, the prompt information is also handed over to the image generation unit 411 together with the input image in the layout data editing screen 700. Explanation of the same processes as those in the above-mentioned embodiments is omitted.

S1401 to S1404 are the same as S801 to S804.

In S1405, the image completion processing unit 402 sets the prompt being supplementary information of the image to be generated, in the prompt setting unit 403. For example, in the case where a head portion of a person is the completion region as illustrated in FIG. 8, the prompt is text information such as “person”, “head”, or “hat”. Moreover, in the case where a tail portion of an animal is the completion region, the prompt is text information such as “animal”, “dog”, or “tail”. The prompt may be estimated by the image completion processing unit 402 from the image information set in the image input unit 404, or set based on user input.

In S1406, the image completion processing unit 402 requests the image generation unit 411 of the server 104 to generate the completed image based on the information set in the image input unit 404, the completion region information, and the information set in the prompt setting unit 403.

S1407 is same as S806.

As explained above, in the present embodiment, generation of the completed image using the prompt is provided for the image with the missing portion, and an image closer to the intention of the user can be thereby provided.

### Embodiment 6

Although the completed image is generated in the image generation unit 411 such that the missing portion of the input image is completed, there is a case where the missing portion is present also in the generated completed image. Accordingly, the following is assumed to be desirable. Whether the missing portion is present in the generated completed image or not is determined. In the case where the missing portion is present, there is generated a re-completed image in which the missing portion of the completed image is completed.

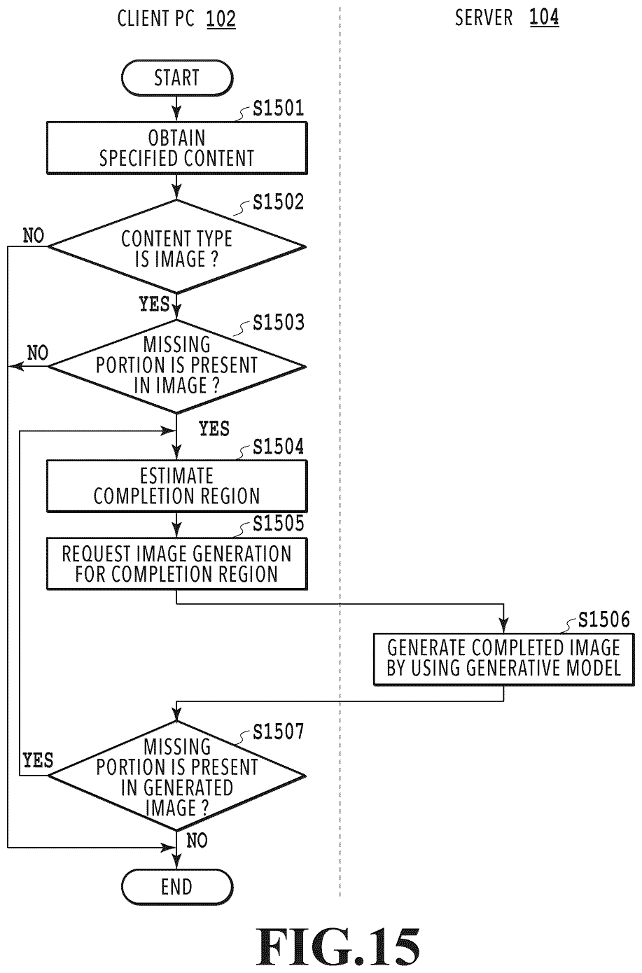

FIG. 15 is an example of a processing flow in which whether the missing portion is present or not is determined also in the generated completed image in the generation of the completed image in the layout data editing screen 700. Explanation of the processes that are the same as those in the above-mentioned embodiments is omitted.

S1501 to S1506 are the same as S801 to S806.

In S1507, the image completion processing unit 402 determines whether or not the missing portion is present in the generated completed image. In the case where the missing portion is absent (No in S1507), the image completion processing unit 402 directly terminates the processing. In the case where the missing portion is present (Yes in S1507), the processing returns to S1504.

In S1504, the image completion processing unit 402 sets the completion region to a region adjacent to the missing portion of the completed image that is in the image input unit 404 and that is generated in S1506. Then, S1505 to S1507 are executed again to generate the re-completed image in which the missing portion of the completed image is completed.

As explained above, in the present embodiment, the completed image without the missing portion can be provided to the user by determining whether or not the missing portion is present in the generated completed image.

### Embodiment 7

Whether to perform the generation of the completed image or not may be received from the user.

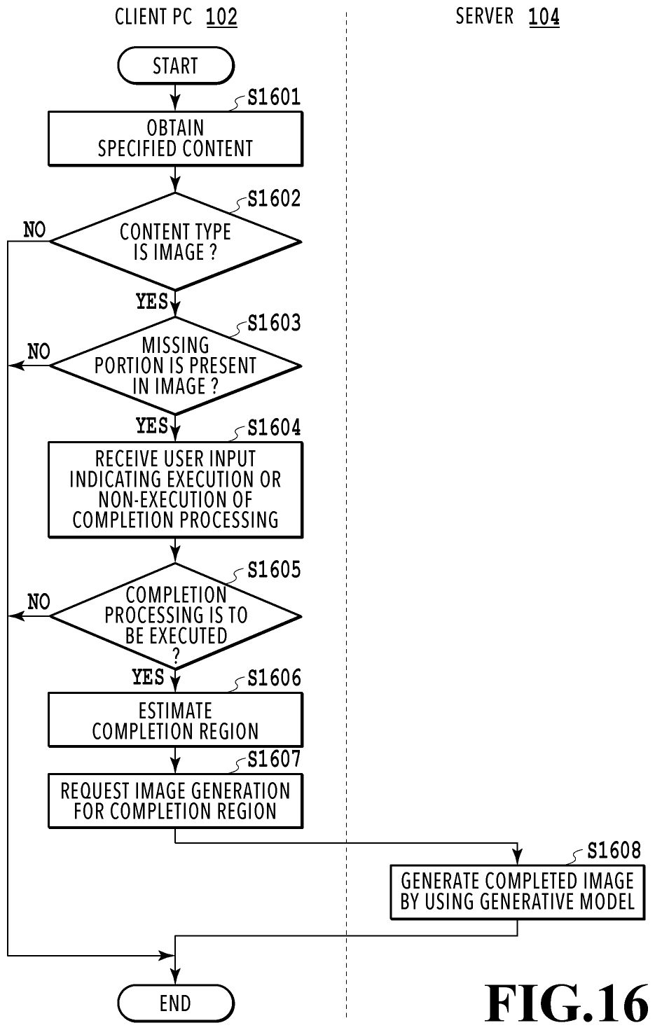

FIG. 16 is an example of a processing flow in which whether the completed image is to be generated or not is received from the user in the case where the missing portion is present in the image in the layout data editing screen 700. Explanation of the processes that are the same as those in the above-mentioned embodiments is omitted.

S1601 to S1603 are the same as S801 to S803.

In S1604, the image completion processing unit 402 displays a dialog in which the user selects whether to generate the completed image or not, and receives a user input indicating execution or non-execution of the completion processing from the user.

In 1605, in the case where the user selects non-execution of the completion processing (No in S1605), the image completion processing unit 402 directly terminates the processing. In the case where the user selects execution of the completion processing (Yes in S1605), the processing proceeds to S1606.

In S1606, the image completion processing unit 402 sets the completion region as in S804.

S1607 to S1608 are the same as S805 to S806.

As explained above, in the present embodiment, the user himself/herself can select whether to generate the completed image or not.

### Embodiment 8

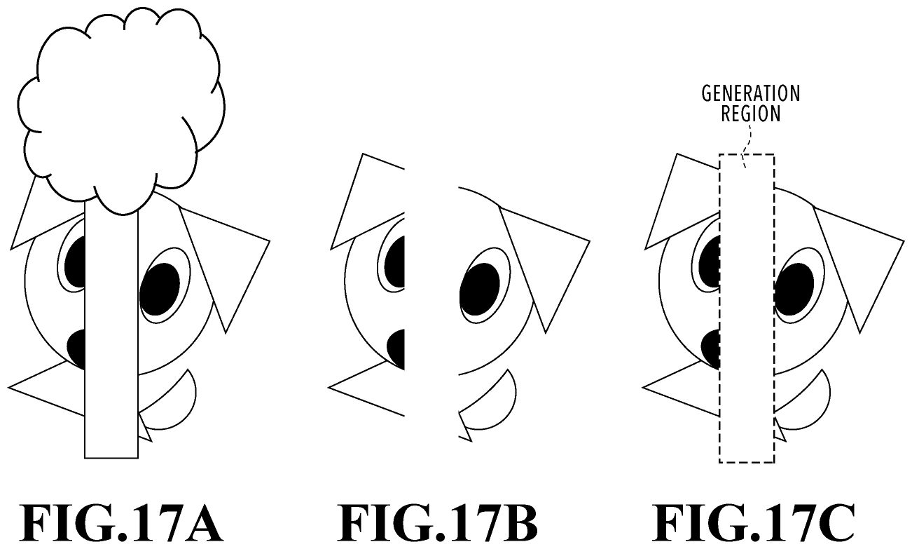

In the case where cut-out of each content is performed, the extracted object is sometimes fragmented depending on the content because part of the extracted object is located behind another object. FIGS. 17A to 17C are an example of the case where the extracted object is fragmented.

FIG. 17A illustrates a content in which a dog is partially hidden behind a tree. FIG. 17B is an example illustrating a result in which objects of the dog are extracted from the content illustrated in FIG. 17A. In the result illustrated in FIG. 17B, the objects of the dog are extracted, but an image of a portion where the tree was present is missing. In the present embodiment, in such a case, the completed image is generated while the missing portion of the objects of the dog, that is the portion where the tree was present between the objects of the dog is set as the completion region as illustrated in FIG. 17C. This enables generation of the completed image desired by the user, and work of the user preparing an image again or the like can be eliminated.

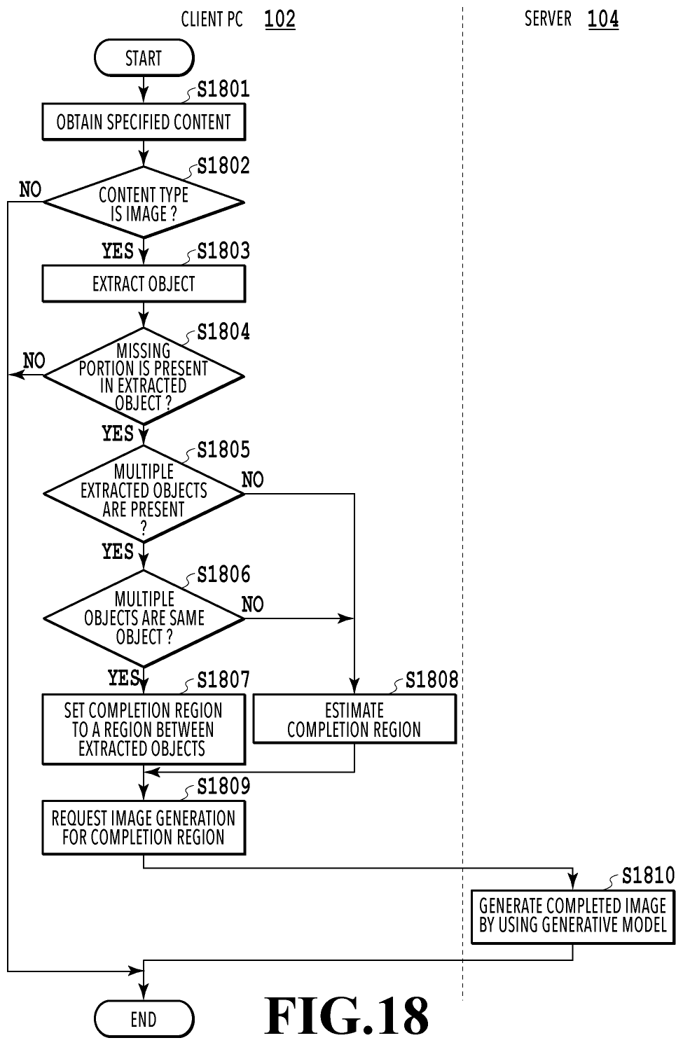

FIG. 18 is an example of a processing flow in which, in the case where the same object is extracted as multiple objects in the cut-out processing performed on the content in the layout data editing screen 700, the completed image is generated with a portion between the multiple objects forming the same object being set as the completion region. Explanation of the processes that are the same as those in the above-mentioned embodiments is omitted.

S1801 to S1804 are the same as S901 to S904.

In S1805, the image completion processing unit 402 determines whether there are multiple extracted objects. In the case where there are no multiple extracted objects (No in S1805), the processing proceeds to S1808. In the case where there are multiple extracted objects (Yes in S1805), the processing proceeds to S1806.

In S1806, the image completion processing unit 402 determines whether the extracted multiple objects are the same object or not. An example of a method of determining whether the multiple objects are the same object or not includes a method of determining the extracted multiple objects as the same object in the case where outlines of the respective extracted multiple objects partially have shapes close to a straight line and these portions with the shapes close to the straight line face each other while being spaced away from each other. Examples of a determination criterion of whether the multiple objects have shapes close to a straight line or not are as follows. For example, Hough transform of detecting a straight line is performed on pixels forming the outlines, and whether or not a parameter of the straight line has a peak within a predetermined width may be used as the determination criterion. Moreover, a regression line is obtained, and whether or not a coefficient of determination of this regression line is a predetermined value or more may be used as the determination criterion. Furthermore, the configuration may be such that setting of objects to be extracted is received from the user in the object extraction of S1803, and the set extracted objects are determined as the same object. In the case where the multiple objects are not the same object (No in S1806), the processing proceeds to S1808. In the case where the multiple objects are the same object (Yes in S1806), the processing proceeds to S1807.

In S1807, the image completion processing unit 402 sets the completion region in a region between the extracted objects forming the same object.

S1808 to S1810 are the same as S1005 to S1007.

As described above, in the present embodiment, the image is completed also in the case where, in execution of cut-out editing of each content, multiple cut-out objects are present and are the same object. Accordingly, work of the user preparing another image again is eliminated as in Embodiment 1. Moreover, the user does not have to separately perform the completion processing, and does not have to stop the layout editing work, by providing the completion function in the cut-out function.

### Embodiment 9

The completion region where the completed image is to be generated may be received from the user.

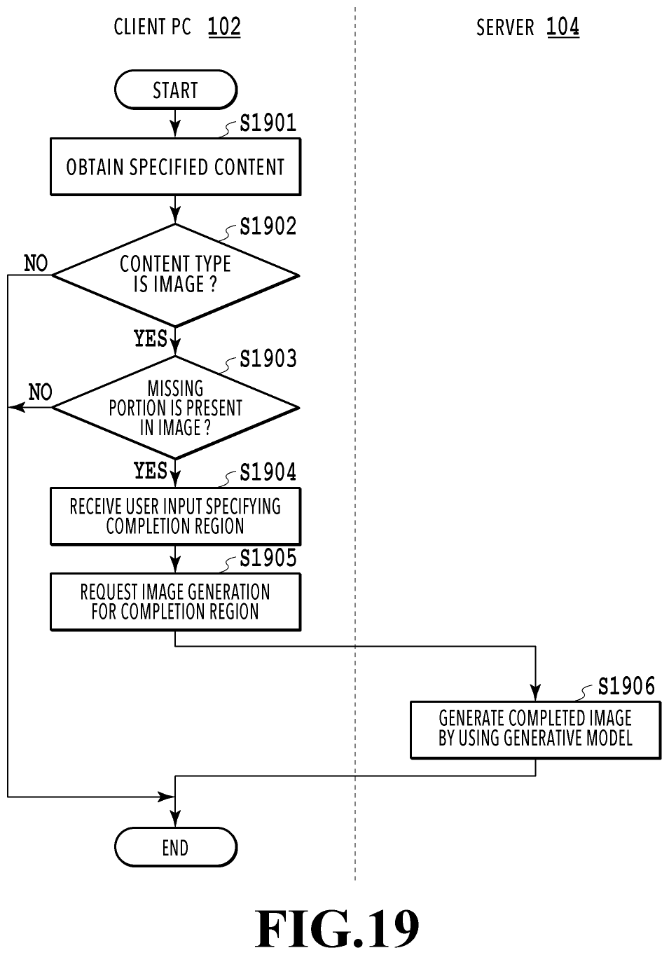

FIG. 19 is an example of a processing flow in which the completion region where the completed image is to be generated is received from the user in the case where the missing portion is present in the image in the layout data editing screen 700. Explanation of the processes that are the same as those in the above-mentioned embodiments is omitted.

S1901 to S1903 are the same as S801 to S803.

In S1904, the image completion processing unit 402 receives a user input specifying the completion region by displaying a dialog in which the user sets the completion region where the completed image is to be generated.

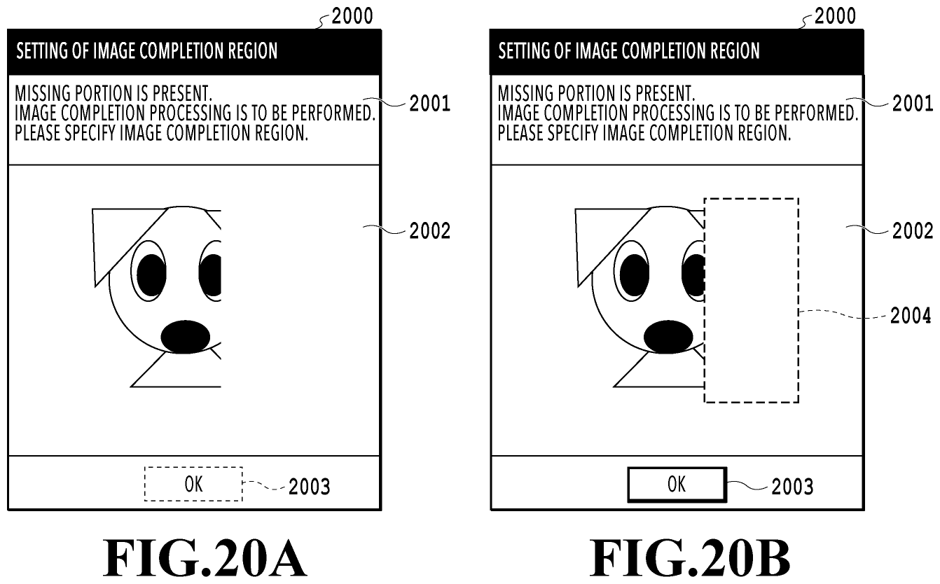

FIGS. 20A and 20B are an example of the dialog in which the user sets the completion region where the completed image is to be generated. A completion region setting dialog 2000 includes a message 2001 that notifies the user of presence of the missing portion in the input image and therefore prompts the user to set the completion region, an image display region 2002 that is used to set the completion region for the input image, and an OK button 2003 that is used to complete the setting.

FIG. 20A is an example of the case where the completion region setting dialog 2000 is activated, and the OK button 2003 is disabled. FIG. 20B is an example of the case where the user sets a completion region 2004 in a region outside and adjacent to the input image in the image display region 2002. Since the completion region 2004 is set in the example illustrated in FIG. 20B, the OK button 2003 is enabled.

Moreover, in the activation of the completion region setting dialog 2000 in FIG. 20A, the completion region set by the image completion processing unit 402 may be displayed as an initial value of the completion region 2004 as in S804. The user can edit the size of the completion region 2004.

S1905 to S1906 are the same as S805 to S806.

As explained above, in the present embodiment, the user himself/herself can set the completion region in which the completed image is to be generated. The user setting the completion region enables the size and location of the completion region to be set as intended by the user.

### Embodiment 10

Whether the completed image is to be generated or not may be determined based on an overlapping state with another content.

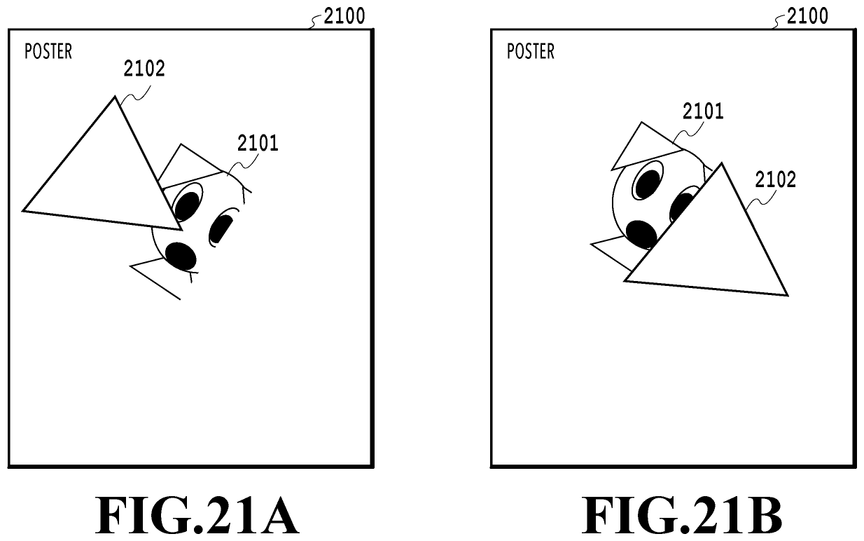

FIGS. 21A and 21B illustrate examples of overlapping of contents arranged in different layers. The examples illustrated in FIGS. 21A and 21B are examples in which a content 2101 of a dog and a content 2102 of a triangle are arranged in different layers in layout data 2100. Moreover, the content 2102 of the triangle is arranged in front of the content 2101 of the dog. Furthermore, the right side of the content 2101 of the dog is missing.

FIG. 21A is an example in which the content 2102 of the triangle is arranged on the left side of the content 2101 of the dog. In this case, since the missing portion of the content 2101 of the dog is visible, a poster or a flyer with a higher level of completeness is assumed to be obtained in the case where the missing portion is completed.

FIG. 21B is an example in which the content 2102 of the triangle is arranged on the right side of the content 2102 of the dog. In this case, since the content 2102 of the triangle is arranged on the missing portion of the content 2101 of the dog to hide the missing portion, the missing portion of the content 2102 of the dog is invisible. Accordingly, the complementation of the missing portion is assumed to be unnecessary.

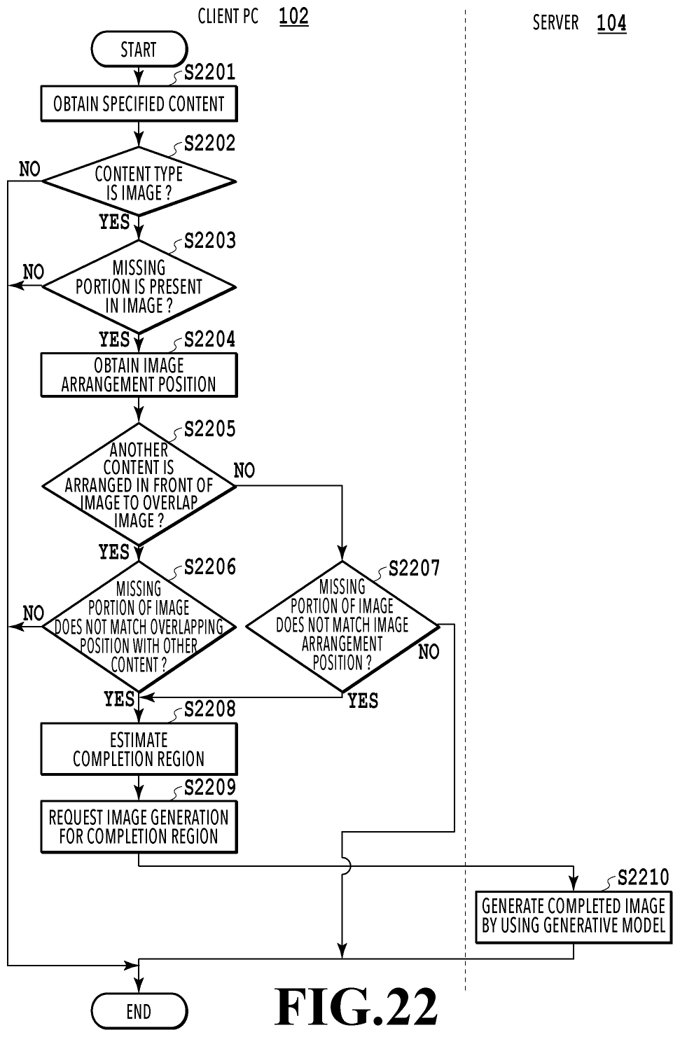

FIG. 22 is an example of a processing flow in which whether the completed image is to be generated or not is determined depending on the overlapping state of the contents in the layout data editing screen 700. Explanation of the processes that are the same as those in the above-mentioned embodiments is omitted.

S2201 to S2204 are the same as S1201 to S1204.

In S2205, the image completion processing unit 402 determines whether another content is arranged in front of the input image with the missing portion to overlap the input image. In the case where another content is arranged in front of the input image to overlap the input image (Yes in S2205), the processing proceeds to S2206. In the case where another content does not overlap the input image (No in S2205), the processing proceeds to S2207.

In S2206, the image completion processing unit 402 determines whether the missing portion of the input image matches an overlapping position with the other content. In the case where the missing portion of the input image matches the position of the other content (No in S2206), the image completion processing unit 402 directly terminates the processing. In the case where the missing portion of the input image does not match the position of the other content (Yes in S2206), the processing proceeds to S2208.

In S2207, the image completion processing unit 402 performs determination of the arrangement position as in S1205.

In S2208, the image completion processing unit 402 sets the completion region as in S1206.

S2209 to S2210 are the same as S1207 to S1208.

As explained above, in the present embodiment, since whether the complementation is to be performed or not is determined depending on the overlapping state of the input image and another content even in the case where the missing portion is present in the input image, unnecessary image generation processing can be eliminated. Moreover, the image generation processing has very high calculation cost, and requires image generation processing time as a matter of course. Eliminating the unnecessary image generation processing leads to reduction of the calculation cost and also to reduction of work time of the user.

### Embodiment 11

It is possible not only to generate multiple completed images as explained in Embodiment 4 but also to specify multiple completion regions and generate multiple completed images.

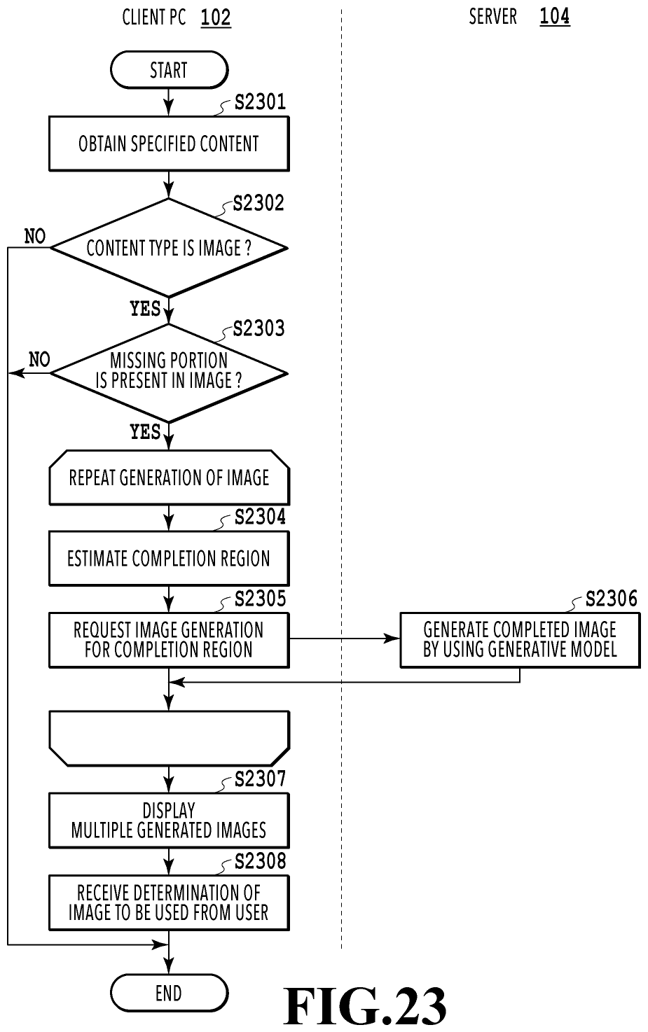

FIG. 23 is an example of a processing flow in which multiple completion regions are set and multiple completed images are generated in the layout data editing screen 700. Explanation of the processes that are the same as those in the above-mentioned embodiments is omitted.

S2301 to S2303 are the same as S1301 to S1303.

In S2304, the image completion processing unit 402 sets the completion region as in S1304, and generates the completed image (S2305 to 2307). In this case, the corresponding generation processing of the completed image is repeated multiple times. The number of times of repeating may be set to a fixed value, be changeable by the user, or be set by the user every time the completed image generation is performed. Moreover, in the case where the completion region is repeatedly set, the setting may be performed with the size, shape, and position of the completion region changed. As a matter of course, the setting of the completion region may be set to a fixed value or be changeable by the user.

S2308 to S2309 are the same as S1308 to S1309.

As explained above, in the present embodiment, the completed images are generated for multiple patterns of the completion regions for the image with the missing portion, and the corresponding multiple completed images are provided. An image closer to the intention of the user can be thereby provided.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to automatically complement the missing portion of the image without ground truth data.

This application claims the benefit of Japanese Patent Application No. 2023-214528 filed Dec. 20, 2023, which is hereby incorporated by reference wherein in its entirety.

What is claimed is:

1. An information processing apparatus comprising:
one or more memories storing instructions; and
one or more processors executing the instructions to:
obtain an input image;
extract an object from the input image;
identify a missing portion of the object extracted by the extracting, based on a shape of an outline of the object; and
generate a completed image in which the missing portion identified in the input image is completed.

2. The information processing apparatus according to claim 1, wherein, in the identifying, in the case where the outline of the extracted object includes a straight line portion, the straight line portion is identified as the missing portion.

3. The information processing apparatus according to claim 2, wherein, in the identifying, a portion of the outline matching an end portion of the input image is determined as the straight line portion.

4. The information processing apparatus according to claim 3, wherein, in the straight line portion, a variation of positions of pixels corresponding to the straight line portion with respect to a straight line calculated based on the positions of the pixels corresponding to the straight line portion is equal to or less than a predetermined threshold.

5. The information processing apparatus according to claim 2, wherein, in the generating, a region that is adjacent to the straight line portion and that is outside the input image is set as a completion region for the input image.

6. The information processing apparatus according to claim 2, wherein, in the generating, in the case where a plurality of the objects are extracted from the input image in the extracting and the plurality of objects are parts forming the same object, a completion region for the input image is set between the plurality of objects forming the same object.

7. The information processing apparatus according to claim 6, wherein, in the generating, in the case where the missing portions of the plurality of objects extracted in the extracting face each other, the plurality of objects are determined to be the parts forming the same object.

8. The information processing apparatus according to claim 1, wherein, in the generating, in the case where cut-out processing of the object is executed on the input image, the completed image is generated.

9. The information processing apparatus according to claim 1, wherein, in the generating, in the case where the missing portion is in a predetermined region, the completed image is generated.

10. The information processing apparatus according to claim 1, wherein, in the generating, a plurality of the completed images different from each other are generated for one of the input image.

11. The information processing apparatus according to claim 1, wherein, in the generating, a text prompt is obtained, and the completed image is generated based on the obtained text prompt.

12. The information processing apparatus according to claim 1, wherein,
in the extracting, the object is extracted from the completed image generated in the generating,
in the identifying, the missing portion of the object extracted from the completed image is identified, and
in the generating, a re-completed image in which the missing portion identified in the completed image is completed is generated.

13. The information processing apparatus according to claim 1, wherein
the one or more processors execute the instructions further to receive a user input, and
in the generating, whether to generate the completed image or not is determined depending on the user input.

14. The information processing apparatus according to claim 1, wherein
the one or more processors execute the instructions further to receive a user input, and
in the generating, the completion region is set based on the user input.

15. The information processing apparatus according to claim 1, wherein, in the generating, in the case where a plurality of the input images are obtained in the obtaining and another input image is arranged on the missing portion, the completed image is not generated.

16. The information processing apparatus according to claim 1, wherein, in the generating, a plurality of the completed images varying in the completion region are generated.

17. The information processing apparatus according to claim 1, wherein, in the extracting, the object with a predetermined attribute is extracted.

18. The information processing apparatus according to claim 1, wherein, in the extracting, a user input specifying the object is obtained, and the object to be extracted is set based on the user input.

19. The information processing apparatus according to claim 1, wherein, in the generating, the completed image is generated by using a generative model machine-learned in advance.

20. The information processing apparatus according to claim 1, wherein the one or more processors execute the instructions further to display the generated completed image on an editing screen of layout data.

21. The information processing apparatus according to claim 20, wherein the editing screen of the layout data is a screen for editing the layout data relating to a printed product or a document.

22. An information processing method comprising:
obtaining an input image;
extracting an object from the input image;
identifying a missing portion of the object extracted by the extracting, based on a feature of an outline of the object; and
generating a completed image in which the missing portion identified in the input image is completed.

23. A non-transitory computer readable storage medium storing a program that causes a computer to execute an information processing method comprising:
obtaining an input image;
extracting an object from the input image;
identifying a missing portion of the object extracted by the extracting, based on a feature of an outline of the object; and
generating a completed image in which the missing portion identified in the input image is completed.
